(19) United States
(12) Patent Application Publication
(10) Pub. No.: US 2017/0007970 A1
(43) Pub. Date: Jan. 12, 2017

(54) Novel Spiral Wound Membrane Leaf Packet for Spiral Wound Filtration Modules

(71) Applicant: Koch Membrane Systems, Inc., Wilmington, MA (US)

(72) Inventors: Michael Baruch, Chelmsford, MA (US); Anthony C Eringis, Tewksbury, MA (US); Thomas C McDermott, JR., Wilmington, MA (US)

(73) Assignee: Koch Membrane Systems, Inc., Wilmington, MA (US)

(21) Appl. No.: 15/198,845

(22) Filed: Jun. 30, 2016

Related U.S. Application Data
(60) Provisional application No. 62/189,619, filed on Jul. 7, 2015.

(51) Int. Cl. B01D 63/10; B01D 67/00; B01D 71/26

(52) U.S. Cl. CPC B01D 63/10; B01D 71/26; B01D 67/0083

(57) ABSTRACT

The present disclosure provides a novel spiral wound membrane leaf packet with a unique substantially non-permeable polymeric resin folding area that has desirable physical and chemical resistance to strong cleaning conditions in industrial filtration applications including food or dairy processing, and the method to make and use the spiral wound membrane leaf packet, and a membrane filtration module that include the novel spiral wound membrane leaf packet.

### RELATED APPLICATIONS

This application claims the benefit of U.S. Provisional Application No. 62/189,619, filed Jul. 7, 2015, which is incorporated by reference in its entirety.

### TECHNICAL FIELD

The present disclosure relates to a novel spiral wound membrane leaf packet that has a unique substantially non-permeable polymeric resin folding area, which has desirable physical and chemical resistance to strong cleaning conditions in industrial filtration applications, including food or dairy processing, the method to make and use the spiral wound membrane leaf packet, and a membrane filtration module that include the novel spiral wound membrane leaf packet.

### BACKGROUND

Spiral wound membrane filtration modules are well known for uses in a variety of fluid mixture separators and purifiers. A typical spiral wound membrane filtration module includes a permeate tube, feed spacers, permeate spacers, and a plurality of spiral wound membrane leaf packets through which a fluid mixture can be separated into different components. A spiral wound membrane leaf packet may be made either by aligning two separate spiral wound membrane sheets along one of their corresponding edges, and sealing the two edges together with a sealant (U.S. Patent Application Publication No. 2014/0014569) or with heat and pressure (U.S. Pat. No. 8,661,648 B2). A spiral wound membrane leaf packet can also be made by simply folding a single spiral wound membrane sheet along the middle line across the width of the spiral wound membrane sheet. In either method, the resulted spiral wound membrane leaf packet has two sections of spiral wound membrane sheet that generally have substantially the identical shape and size. In a folded spiral wound membrane leaf packet, the membrane material sides of the two spiral wound membrane sheet sections face each other toward inside of the folded spiral wound membrane leaf packet, and the spiral wound membrane sheet backing sides are on the outside of the folded spiral wound membrane leaf packet. An optional feed spacer that has a relatively large mesh size to accommodate fluid flow may be positioned between the two membrane sides within the spiral wound membrane leaf packet.

It is known in the art that a typical spiral wound membrane filtration module may be made by winding permeate spacers and spiral wound membrane leaf packets that optionally have a feed spacer in each folded spiral wound membrane leaf packet, around a permeate tube. The permeate passes through the membrane surface of the spiral wound membrane leaf packet and is directed to the permeate tube. Concentrate is removed from one end of the spiral wound membrane filtration module and permeate is removed from the permeate tube.

A spiral wound membrane leaf packet is made of a spiral wound membrane sheet, which is folded upon itself or made of two spiral wound membrane sheets by sealing their two corresponding edges together, and this folded or sealed area often suffers mechanical stresses both at the crease or the sealed edge, and at the contact point with the adjacent permeate carrier sheet. The areas with mechanical stresses are more susceptible to have structural defects or suffer damage, especially under certain harsh chemical conditions.

Many spiral wound membrane filtration applications involve food or dairy processing, where sanitary conditions must be strictly maintained. Spiral wound membrane leaf packets in such spiral separation filtration modules are cleaned frequently by solutions with chemicals that may contain high concentrations of oxidizing agents, such as chlorine, and strong acids or bases. These cleaning conditions tend to penetrate and degrade membrane material, particularly in the membrane folded or sealed areas that are subject to stresses, structural defects, and damage. Once the stressed areas are damaged, leakage could occur from the feed side to the permeate side of the filtration module and negatively affect the whole separation process. Even if leakage does not happen, the damaged area may create an unsanitary condition where bacteria can be harbored, making the filtration system unsuitable for food and dairy process plants where products are made for human consumption.

It is generally desirable to use certain reinforcing methods in the folded areas to counter the stresses and prolong the life of the spiral wound membrane leaf packet. U.S. Pat. No. 8,661,648 disclosed two reinforcing methods. The first reinforcement method is to apply a tape and certain sealant to reinforce the folded area. The second reinforcement method is to apply heat and pressure to seal the folded area. In the method with sealant and tape, the sealant and tape eventually may lose its adhesion and peel away. The reinforcement at the folded area by heat and pressure may create new stress points along the joint area. Either method may lead to defects and damage as a result of exposure to cleaning chemicals, such as chlorine, and become unsanitary for food and dairy treatment purposes.

U.S. Pat. No. 5,147,541 discloses a different method to reinforce the folded area by fusing the membrane sheet near the folded area, optionally with certain reinforcing strip, instead of using adhesive to attach a tape to strengthen the folded area, as disclosed in U.S. Pat. No. 8,661,648. To achieve satisfactory results, a relatively wide fusing area is required, which makes the process to manufacture such membrane sheet leaf packet lengthy and thus costly.

Thus, there exists a need for an improved spiral wound membrane leaf packet with a folded area that is physically and chemically strong enough to resist dairy cleaning conditions, methods for a more efficient process to make such spiral wound membrane leaf packet, and a membrane filtration module that includes the improved spiral wound membrane leaf packet.

### SUMMARY

Compared to other methods in the art for reinforcing the folded area for a spiral wound membrane leaf packet, the present disclosure provides a completely new approach by introducing a novel spiral wound membrane leaf packet that has a unique substantially non-permeable polymeric resin folding area, which has desirable physical and chemical resistance to strong cleaning conditions in filtration applications involving food or dairy processing. Certain tests described herein have demonstrated that a spiral wound membrane leaf packet with such a substantially non-permeable polymeric resin folding area provides desirable results with such cleaning conditions.

In one embodiment, the present disclosure provides a spiral wound membrane leaf packet comprising two spiral wound membrane sheet sections, one substantially non-permeable polymeric resin folding section, and two fused sections, wherein the first fused section is formed by fusing a first longitudinal edge of the substantially non-permeable polymeric resin sheet to one edge of the first spiral wound membrane sheet, and the second fused section is formed by fusing a second longitudinal edge of the substantially non-permeable polymeric resin sheet to one edge of the second spiral wound membrane sheet.

In one embodiment, the present disclosure provides a spiral wound membrane leaf packet comprising two spiral wound membrane sheet sections, one substantially non-permeable polymeric resin folding section, and two fused sections, wherein the first fused section is formed by fusing a first longitudinal edge of the substantially non-permeable polymeric resin sheet to one edge of the first spiral wound membrane sheet, and the second fused section is formed by fusing a second longitudinal edge of the substantially non-permeable polymeric resin sheet to one edge of the second spiral wound membrane sheet, and the two resulted spiral wound membrane sheet sections have the membrane material sides on the same face of the spiral wound membrane leaf packet.

In one embodiment, the present disclosure provides a spiral wound membrane leaf packet comprising two spiral wound membrane sheet sections, one substantially non-permeable polymeric resin folding section, and two fused sections, wherein the first fused section is formed by fusing a first longitudinal edge of the substantially non-permeable polymeric resin sheet to one edge of the first spiral wound membrane sheet, and the second fused section is formed by fusing a second longitudinal edge of the substantially non-permeable polymeric resin sheet to one edge of the second spiral wound membrane sheet, and the two resulted spiral wound membrane sheet sections have the membrane material sides on the same face of the spiral wound membrane leaf packet, and the two fused sections are formed by applying heat and pressure from the spiral wound membrane sheet membrane side toward the spiral wound membrane sheet backing side, and the substantially non-permeable polymeric resin sheet is laid against the spiral wound membrane sheet backing side.

In another embodiment, the present disclosure provides a spiral wound membrane filtration module comprising one permeate tube, one or more permeate spacers, optionally one or more feed spacer, and one or more spiral wound membrane leaf packets, wherein said spiral wound membrane leaf packet comprises a substantially non-permeable polymeric resin folding section.

In another embodiment, the present disclosure provides a spiral wound membrane filtration module comprising one permeate tube, one or more permeate spacers, optionally one or more feed spacers, and one or more spiral wound membrane leaf packets, wherein said spiral wound membrane leaf packet comprises at least two spiral wound membrane sheet sections, at least one substantially non-permeable polymeric resin folding section, and at least two joint sections, wherein the at least two joint sections are each between one membrane sheet section and the substantially non-permeable polymeric resin folding section.

In another embodiment, the present disclosure provides a spiral wound membrane filtration module comprising one permeate tube, one or more permeate spacers, optionally one or more feed spacers, and one or more spiral wound membrane leaf packets, wherein said spiral wound membrane leaf packet comprises at least two spiral wound membrane sheet sections, at least one substantially non-permeable polymeric resin folding section, and at least two fused sections, wherein the at least two fused sections are each between one membrane sheet section and the substantially non-permeable polymeric resin folding section.

In another embodiment, the present disclosure provides a spiral wound membrane filtration module comprising one permeate tube, one or more permeate spacers, optionally one or more feed spacer, and one or more spiral wound membrane leaf packets, wherein said spiral wound membrane leaf packet comprises two spiral wound membrane sheet sections, one substantially non-permeable polymeric resin folding section, and two joint sections, wherein the two joint sections are each between one spiral wound membrane sheet section and the substantially non-permeable polymeric resin folding section.

In another embodiment, the present disclosure provides a spiral wound membrane filtration module comprising one permeate tube, one or more permeate spacers, optionally one or more feed spacer, and one or more spiral wound membrane leaf packets, wherein said spiral wound membrane leaf packet comprises two spiral wound membrane sheet sections, one substantially non-permeable polymeric resin folding section, and two fused sections, wherein the two fused sections are each between one spiral wound membrane sheet section and the substantially non-permeable polymeric resin folding section.

In another embodiment, the present disclosure provides a method to use a spiral wound membrane leaf packet in a purification or separation process, wherein said spiral wound membrane leaf packet comprises a substantially non-permeable polymeric resin folding section.

In another embodiment, the present disclosure provides a method to use a spiral wound membrane leaf packet in a purification or separation process, wherein said spiral wound membrane leaf packet comprises at least two spiral wound membrane sheet sections, at least one substantially non-permeable polymeric resin folding section, and at least two joint sections, wherein the at least two joint sections are each between one spiral wound membrane sheet section and the substantially non-permeable polymeric resin folding section.

In another embodiment, the present disclosure provides a method to use a spiral wound membrane leaf packet in a purification or separation process, wherein said spiral wound membrane leaf packet comprises at least two spiral wound membrane sheet sections, at least one substantially non-permeable polymeric resin folding section, and at least two fused sections, wherein the at least two fused sections are each between one spiral wound membrane sheet section and the substantially non-permeable polymeric resin folding section.

In another embodiment, the present disclosure provides a method to use a spiral wound membrane leaf packet in a purification or separation process, wherein said spiral wound membrane leaf packet comprises two spiral wound membrane sheet sections, one substantially non-permeable polymeric resin folding section, and two joint sections, wherein the two joint sections are each between one spiral wound membrane sheet section and the substantially non-permeable polymeric resin folding section.

In another embodiment, the present disclosure provides a method to use a spiral wound membrane leaf packet in a purification or separation process, wherein said spiral wound membrane leaf packet comprises two spiral wound membrane sheet sections, one substantially non-permeable polymeric resin folding section, and fused sections, wherein the two fused sections are each between one spiral wound membrane sheet section and the substantially non-permeable polymeric resin folding section.

In another embodiment, the invention provides a process to make a spiral wound membrane leaf packet comprising fusing a spiral wound membrane sheet to a substantially non-permeable polymeric resin sheet.

In another embodiment, the invention provides a process to make a spiral wound membrane leaf packet comprising at least two spiral wound membrane sheet sections, at least one substantially non-permeable polymeric resin folding section, and at least two fused sections, wherein the first fused section is formed by fusing a first longitudinal edge of the substantially non-permeable polymeric resin sheet to one edge of the first spiral wound membrane sheet, and the second fused section is formed by fusing a second longitudinal edge of the substantially non-permeable polymeric resin sheet to one edge of the second spiral wound membrane sheet, and the two resulted spiral wound membrane sheet sections have the membrane material sides on the same face of the spiral wound membrane leaf packet, and the two fused sections are formed by applying heat and pressure from the spiral wound membrane sheet membrane side toward the spiral wound membrane sheet backing side, and the substantially non-permeable polymeric resin sheet is laid against the spiral wound membrane sheet backing side.

In another embodiment, the invention provides a process to make a spiral wound membrane leaf packet, wherein the process comprises:

a) providing a spiral wound membrane sheet comprising a membrane side and a membrane backing side;

b) providing a substantially non-permeable polymeric resin sheet and placing said substantially non-permeable polymeric resin sheet against said membrane sheet backing side, wherein a longitudinal direction of said substantially non-permeable polymeric resin sheet is perpendicular to a longitudinal direction of said spiral wound membrane sheet;

c) applying heat and pressure from said membrane side toward said backing side and fusing said spiral wound membrane sheet and said substantially non-permeable polymeric resin sheet along a first longitudinal edge of said substantially non-permeable polymeric resin sheet to form the first fused section;

d) applying heat and pressure from said membrane side toward said backing side and fusing said spiral wound membrane sheet and said substantially non-permeable polymeric resin sheet along a second longitudinal edge of said substantially non-permeable polymeric resin sheet to form the second fused section; and

e) removing the middle un-fused spiral wound membrane sheet section between the two fused sections to provide the completed spiral wound membrane leaf packet;

wherein the step c) and step d) can be performed sequentially or substantially simultaneously, and said completed spiral wound membrane leaf packet has two spiral wound membrane sheet sections, one substantially non-permeable polymeric resin folding section, and two fused sections.

In another embodiment, the present disclosure provides an alternative process to make a spiral wound membrane leaf packet, wherein the process comprises:

a) providing two individual substantially identical spiral wound membrane sheets comprising a membrane side and a backing side;

b) providing a substantially non-permeable polymeric resin sheet;

c) disposing one edge of the first spiral wound membrane sheet on top of part of the substantially non-permeable polymeric resin sheet along a first longitudinal edge of the substantially non-permeable polymeric resin sheet, and disposing one edge of the second spiral wound membrane sheet on top of part of the substantially non-permeable polymeric resin sheet along the second longitudinal edge of the substantially non-permeable polymeric resin sheet, with the substantially non-permeable polymeric resin sheet in contact with the backing side of the two spiral wound membrane sheets;

d) applying heat and pressure from the membrane side toward the backing side and fusing the spiral wound membrane sheet and the substantially non-permeable polymeric resin sheet along the first longitudinal edge of the substantially non-permeable polymeric resin sheet to form the first fused section; and

e) applying heat and pressure from the membrane side toward the backing side and fusing the spiral wound membrane sheet and the substantially non-permeable polymeric resin sheet along the second longitudinal edge of substantially non-permeable polymeric resin sheet to form the second fused section;

wherein step d) and step e) can be performed sequentially or substantially simultaneously, and the completed spiral wound membrane leaf packet has two spiral wound membrane sheet sections, one substantially non-permeable polymeric resin folding section, and two fused sections.

In any embodiment of the present disclosure that relates to a spiral wound membrane leaf packet, a suitable substantially non-permeable polymeric resin can be but is not limited to an ionomer resin.

In any embodiment of the present disclosure that relates to a spiral wound membrane leaf packet, a preferred substantially non-permeable polymeric resin is an ethylene and methacrylic acid copolymer, in which the acid groups are partially neutralized with either zinc or sodium.

In any embodiment of the present disclosure that relates to a spiral wound membrane leaf packet, a preferred substantially non-permeable polymeric resin is Surlyn®, which is manufactured by E.I. du Pont de Nemours and Company, Inc.

The advantages of the spiral wound membrane leaf packet of the present disclosure include, but are not limited to, a unique substantially non-permeable polymeric resin folding section with desirable physical and chemical resistance to strong cleaning conditions in industrial filtration applications including food or dairy processing, and a substantially more efficient process in preparing such a spiral wound membrane leaf packet.

### BRIEF DESCRIPTION OF THE DRAWINGS

It is understood that the dimensions such as the thickness, length, or width of each section in any of the illustrated spiral wound membrane leaf packets may be exaggerated in each figure for the sole purpose of illustration. It should not be considered the actual or relative thickness, length, or width of any section of the membrane leaf packet in each figure.

FIG. 1 is a partial cut away perspective view of a spiral wound membrane module, according to an exemplary embodiment.

FIG. 2 is a perspective top view from a membrane side of an un-folded spiral wound membrane leaf packet of the spiral wound membrane module of FIG. 1.

FIG. 3 is a perspective side view of the un-folded spiral wound membrane leaf packet of FIG. 2.

FIG. 4 is a perspective side view of the folded spiral wound membrane leaf packet of FIGS. 2 and 3.

FIG. 5 is a perspective side view of a step of a process to make a spiral wound membrane leaf packet with one membrane sheet and one substantially non-permeable polymeric resin sheet.

FIG. 6 is a perspective side view of another step of the process to make a spiral wound membrane leaf packet with one membrane sheet and one substantially non-permeable polymeric resin sheet.

FIG. 7 is a perspective side view of a process to make a spiral wound membrane leaf packet with two separate membrane sheets and one substantially non-permeable polymeric resin sheet.

FIG. 8 is perspective side view of a spiral wound membrane leaf packet manufactured in accordance with Example 1.

FIG. 9 is a perspective side view of the spiral wound membrane leaf packet of FIG. 8 folded.

### DETAILED DESCRIPTION

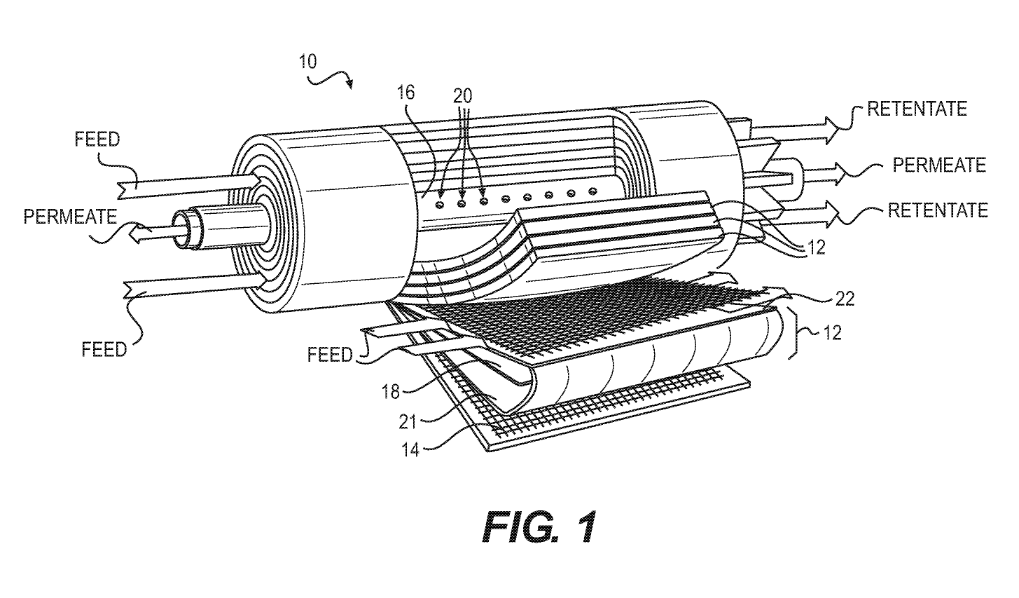

FIG. 1 illustrates a partial cut away perspective view of a spiral wound membrane module 10, according to an exemplary embodiment. Spiral wound membrane module 10 may include a plurality of spiral wound membrane leaf packets 12 through which a feed stream may be separated into different streams (e.g., a permeate stream and a retentate stream). The feed stream may flow along spiral wound membrane leaf packets 12 through a feed spacer sheet 14, which may be inserted between adjacent spiral wound membrane leaf packets 12. The portion of the feed stream that permeates through spiral wound membrane leaf packets 12 may be referred to as permeate and may be directed toward a permeate tube 16. In some embodiments, a permeate spacer 18 may be positioned within each spiral wound membrane leaf packet 12 to facilitate flow of the permeate toward permeate tube 16. The permeate may enter permeate tube through one of the plurality of permeate collection holes 20 positioned along permeate tube 16. The permeate may then exit from spiral wound membrane module 10 at one or both ends, as shown in FIG. 1.

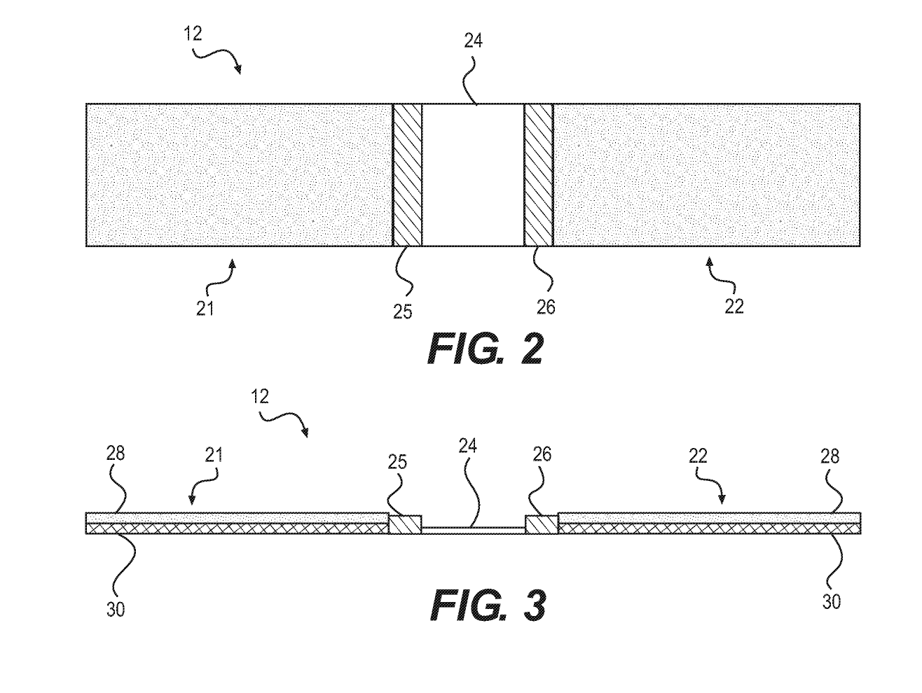

FIG. 2 illustrates a perspective top view of an un-folded spiral wound membrane leaf packet 12, according to an exemplary embodiment. Spiral wound membrane leaf packet 12 may include at least two spiral wound membrane sheet sections 21, 22, a substantially non-permeable polymeric resin folding section 24, and two fused sections 25, 26.

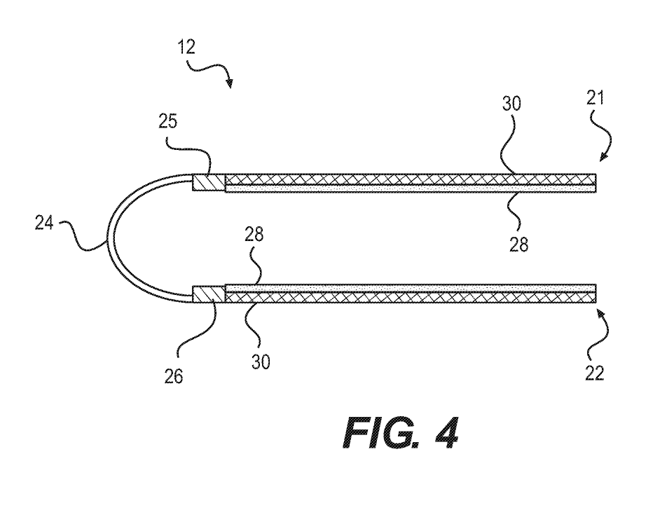

Spiral wound membrane sheet sections 21, 22 typically may comprise a membrane material layer 28 and a backing material layer 30, as shown in FIG. 3. Membrane material layer 28 and backing material layer 30 may be integrally joined by techniques well-known in the art to form spiral wound membrane sheet sections 21, 22. Membrane sheet sections 21, 22, as shown in FIG. 3, illustrate a two-layer structure wherein the membrane material layer is positioned on top of backing material layer 30. Spiral wound membrane leaf packets 12 may typically be in a folded form, as shown in FIG. 4.

Acceptable materials for membrane material layer 28 may include a wide range of thermoplastic resins that can be fabricated into a sheet having a pore structure and filtration capability. For example, well-known thermoplastic membrane materials include polysulfone, polyvinylidene fluoride, polyethersulfone, polyarylsulfone, polyvinylchloride, polyamides, cellulose acetate, polycarbonates, polytetrafluoroethylene, polyphenylene sulfide, polyethylene, polyethyleneterephthalate, polyamide-imide, and polypropylene. Natural membrane materials such as cellulose may also be employed. Preferred materials include polyethersulfone and polyvinylidene fluoride.

Acceptable materials for backing material layer 30 may include, for example, woven or nonwoven synthetic materials having the strength necessary to reinforce the membrane and the ability to be integrally bound to the membrane while not interfering with the passage of permeate through the membrane. Suitable backing materials include polyester, polypropylene, polyethylene, and the family of polyamide polymers generally referred to as “nylon.”

An acceptable material for substantially non-permeable polymeric resin folding section 24, which can be considered as a bridge of the two spiral wound membrane sheet sections 21, 22, is preferably physically and chemically strong enough to resist a harsh cleaning environment with strong chemicals such as caustic and chlorine. In addition, an acceptable material for substantially non-permeable polymeric resin folding section 24 is preferably compatible with and able to be integrally joined to spiral wound membrane sheet sections 21, 22. Furthermore, an acceptable material for substantially non-permeable polymeric resin folding section 24 preferably has enhanced performance in areas such as liquid permeation resistance, abrasion resistance, scuff resistance, melt strength, and direct adhesion capability to fibers by heat lamination. An acceptable material for substantially non-permeable polymeric resin folding section 24 may be any polymer material that substantially meets one or more of the above mentioned characteristics. A preferred acceptable material for substantially non-permeable polymeric resin folding section 24 may be chosen from suitable ionomer resins. For example, a preferred acceptable material may be an ethylene and methacrylic acid copolymer, in which the acid groups are partially neutralized with either zinc or sodium ion. The acid in the polymer gives polarity and reduces crystallinity. The ionic bonding between the polymer chains gives outstanding melt strength, toughness, and clarity. One suitable ethylene and methacrylic acid copolymer material is sold under the trademark SURLYN®, which is manufactured by E.I. du Pont de Nemours and Company, Inc.

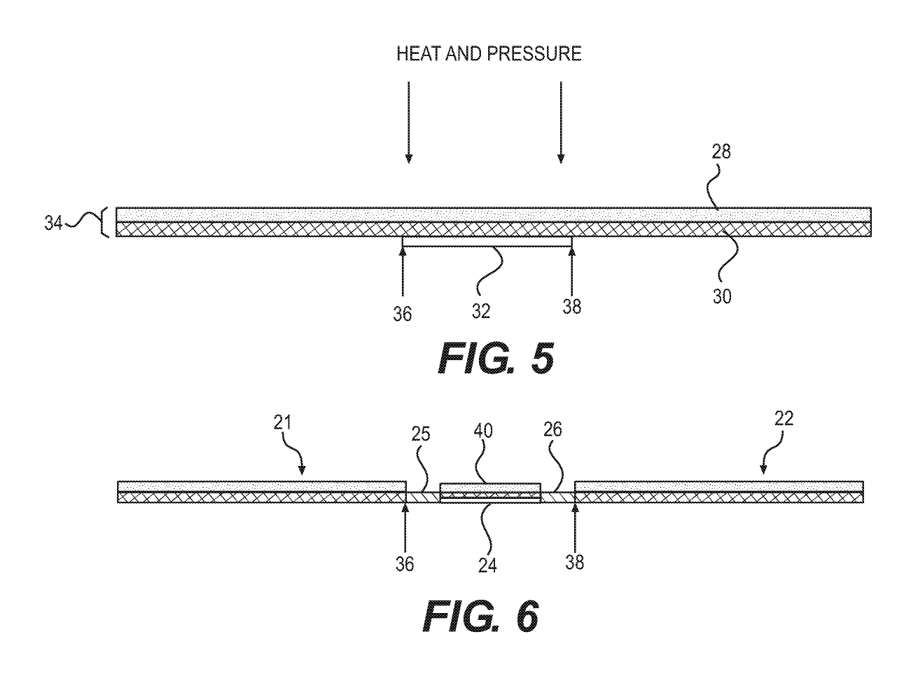

Methods of manufacturing spiral wound membrane leaf packet 12 will now be explained with reference to FIGS. 5-7. One embodiment of a fusing process to make spiral wound membrane leaf packet 12 is illustrated in FIGS. 5 and 6. First, as illustrated in FIG. 5, the method may include laying a suitable substantially non-permeable polymeric resin sheet 32 on a surface, and then laying a membrane sheet 34 on top of substantially non-permeable polymeric resin sheet 32 so that a longitudinal direction of substantially non-permeable polymeric resin sheet 32 is perpendicular to a longitudinal direction of membrane sheet 34. Then, as illustrated in FIG. 5, the method may include applying heat and at least nominal pressure with a suitable thermal sealer from the membrane material layer side of membrane sheet 34 along a first longitudinal edge 36 of non-permeable polymeric resin sheet 32. Once the fusion is finished, the same fusing process may be applied to the other side along a second longitudinal edge 38 of non-permeable polymeric resin sheet 38. The fusing process, which forms fused sections 25, 26 may be carried out either sequentially or substantially simultaneously. It some embodiments, it is contemplate that the method may include applying just heat.

FIG. 6 illustrates the result of the fusion. As shown in FIG. 6, fused sections 25, 26 will be produced by the fusion along first and second longitudinal edges 36, 38, and membrane sheet 34 as shown in FIG. 5 will be separated into spiral wound membrane sheet sections 21, 22 and a membrane sheet section 40 positioned between fused sections 25, 26. Membrane sheet section 40 may be removed to produce spiral wound membrane leaf packet 12, as shown in FIGS. 2 and 3.

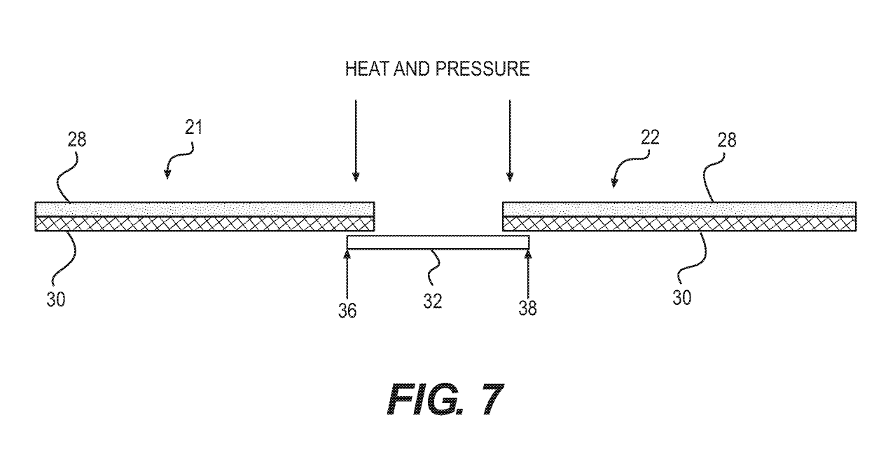

An alternative fusing process to manufacture spiral wound membrane leaf packet 12 will now be discussed with reference to FIG. 7. The fusing process of FIG. 7 may be the same as the fusing process described above with reference to FIGS. 5 and 6 except that it begins with spiral wound membrane sheet sections 21, 22 already separated as illustrated in FIG. 7. Spiral wound membrane sheet sections 21, 22 may be positioned along first and second longitudinal edges 36, 38 such that spiral wound membrane sheet sections 21, 22 overlap substantially non-permeable polymeric resin sheet 32 an amount suitable for the fusing process. This fusing process may also result in the production of membrane leaf packet 12, as shown in FIGS. 2 and 3. The fusing process along first and second longitudinal edges 36, 38 may be done sequentially or substantially simultaneously.

In some embodiments, a length of the whole unfolded spiral wound membrane leaf packet 12 may have a range of about 150 cm to about 400 cm. In some embodiments, substantially non-permeable polymeric resin folding section 24 may have a width that ranges from about 0.5 cm to about 20.0 cm. A preferred width of substantially non-permeable polymeric resin folding section 24 may have a range from about 2.0 cm to about 10.0 cm. A more preferred width of substantially non-permeable polymeric resin folding section 24 may have a range from about 3.0 cm to about 7.5 cm.

In some embodiments, a width of fused sections 25, 26 for membrane leaf packet 12 may have a range from about 0.5 cm to about 10 cm. A preferred width of fused areas 25, 26 may have a range from about 0.75 cm to about 5.0 cm. A more preferred width of fused areas 25, 26 may have a range from about 1.0 cm to about 1.5 cm.

The fusing temperature may vary depending on the different materials used for membrane material layer 28, backing material layer 30, and substantially non-permeable polymeric resin sheet 32. For example, the fusing temperature may have a range from about 100-350° C. A preferred fusing temperature may have a range from about 120-300° C. A more preferred fusing temperature may have a range from about 150-270° C.

The fusing process may be applied at a substantially fixed temperature or the temperature may be gradually increased. For example, in some embodiments the process may include first applying an initially un-heated heating fixture, and increase the temperature of the heating fixture to a point that is close to the glass transition temperature at the fusing sections. Once the temperature reaches the glass transition temperature, the process may call for holding the temperature at that point for a period of time until the fusing process is substantially completed. The process may then call for letting the fused section cool down to ambient temperature.

For the fusing process, it may be beneficial to secure or attach non-permeable polymeric resin sheet 32 against backing material layer 30 of membrane sheet 34. For the fusing process, it may be preferable to apply the heat and pressure, as shown in FIGS. 5 and 7, toward backing material layer 30 from membrane material layer 28 of membrane sheet 34 or spiral wound membrane sheet sections 21, 22. A reliable indication of when the desired level of fusion has been achieved for the preferred polyethersulfone membrane may be when the membrane appearance changes from milky white to highly translucent.

As a result of the heat and pressure applied, there may exist a temperature gradient from the membrane side of membrane sheet 34 or spiral wound membrane sheet sections 21, 22 to substantially non-permeable polymeric resin sheet 32. Thus, to achieve a substantially homogeneous fused composite in fused sections 25, 26, of membrane material layer 28, backing material layer 30, and non-permeable polymeric resin sheet 32, a glass transition temperature of the material of membrane material layer 28 may be higher than the material of backing material layer 30, and a glass transition temperature of the material of backing material layer 30 may also typically be higher than a glass transition temperature of the material of non-permeable polymer resin sheet 32.

### Example 1

### Preparation of a Spiral Wound Membrane Leaf Packet

The purpose of Example 1 is to describe one method of making a spiral wound membrane leaf packet 12, according to an exemplary embodiment. The method may include the following steps. Prepare a clean and flat surface. Unroll a desired length of Surlyn® sheet (grade: 1652; width: about 7.94 cm±0.16 cm; length: about 117 cm; supplier: Berry Plastic Corp.) and lay it on a flat surface. Then unroll a desired length of spiral wound membrane sheet (approximately 275 cm long and approximately 104 cm wide) and lay it on top of the Surlyn® sheet with the spiral wound membrane backing side in contact with the Surlyn® sheet. The longitudinal direction of the Surlyn® sheet is in perpendicular alignment to the longitudinal direction of the spiral wound membrane sheet, and the longitudinal middle line of the Surlyn® sheet aligns substantially to the middle line of the spiral wound membrane sheet across the width. Tape may be used at certain places of both the spiral wound membrane sheet and the Surlyn® sheet to make sure neither sheet moves during the whole process.

Thermal impulse equipment (Model: HD-72, Aline Heat Seal Corp.) may be used for the fusing process, as described herein. The thermal impulse equipment may comprise: an “active” or top bar which provides the heating and cooling; an “inactive” or bottom bar which supports the Surlyn® membrane from the Surlyn® side; a frame; electrical controls and circuitry; and a cooling unit and related controls. The top bar may include a ⅜″ wide nichrome wire connected at the ends to the electrical circuitry. Behind the wire (remote from the membrane) may be a cooling channel which is connected to the cooling unit by basic plumbing. A Teflon® coated fiberglass sheet (Genalco Inc., woven fiberglass cloth coated with polytetrafluoroethylene (PTFE) based fluoropolymer resin with a thickness of about 0.25 mm, a width of about 82.55 mm, and about 6.35 mm wide adhesive on each side of the outer edge) may be used to wrap over the nichrome wire and may be fastened in place along the length so that the wire is sealed off lengthwise from the membrane. The bottom bar may be a supported rubber pad only slightly wider than the nichrome wire. This rubber pad may also be covered with a Teflon® coated fiberglass sheet to prevent contact between the Surlyn® and the rubber pad. On top of the Teflon® coated fiberglass sheet that covers the bottom bar are attached two polyetheretherketone (PEEK) films (about 7.5-8.0 cm long and 7.5-8.0 cm wide, AIN Plastics). The two PEEK films may be used to prevent direct contact between the bottom Teflon® coated fiberglass sheet and the Surlyn® sheet for a span of about 7.6 cm from either outer edge of the membrane width (for 104 cm wide membrane, the two PEEK films are located in the 0 to about 7.6 cm region and the about 96.5 to 104 cm regions, respectively.)

The top and the bottom bars of the thermal impulse equipment may be parallel to the longitudinal direction of the Surlyn® sheet. The fusing area may be about 0.95 cm wide along both longitudinal edges of the Surlyn® sheet. The center area of the Surlyn® sheet and the corresponding spiral wound membrane sheet section are not fused.

Lower the top bar of the thermal impulse equipment to touch the membrane material side of the spiral wound membrane sheet along the first longitudinal edge of the Surlyn® sheet. Preheat the thermal impulse heating fixture to about 120° C. (±5° C.). The pressure applied may be about 550 kilopascals (kPa). The temperature may then be increased from about 120° C. to about 173° C. (±3° C.) and held at about 173° C. for about 14 seconds (±2 seconds). Then the first fused area may be allowed to cool to about 33° C. before repeating the same process on the spiral wound membrane sheet along the second longitudinal side of the Surlyn® sheet. The total cycle time for the fusing process from the touching between the thermal impulse heating fixture and the membrane side may be about 26 seconds.

The same procedure as described for the first fusing area on the spiral wound membrane sheet may be repeated along the second longitudinal side of the Surlyn® sheet.

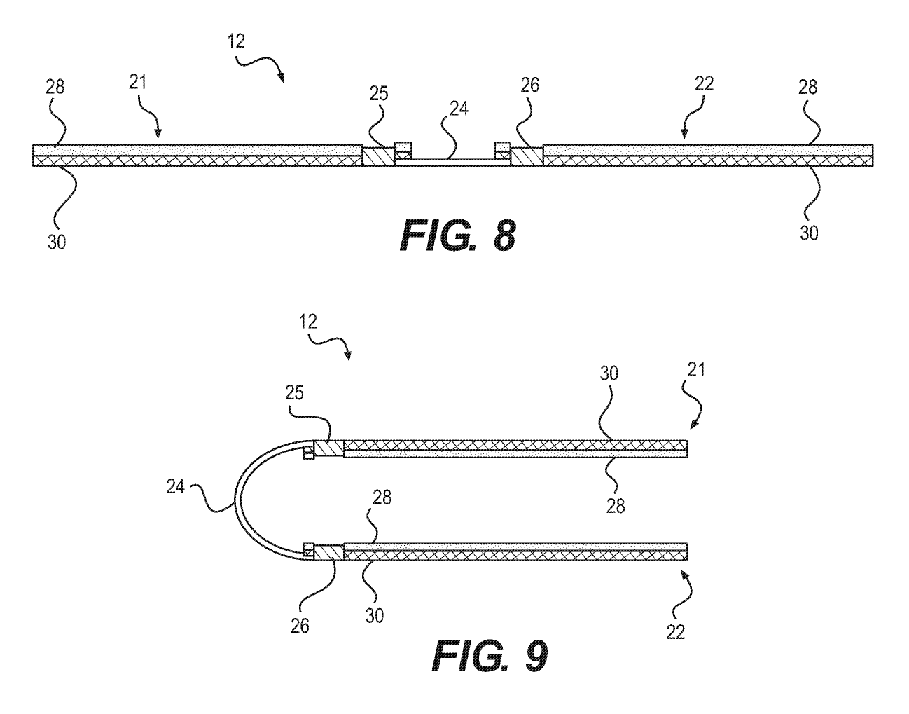

After the fused areas are cooled to room temperature, carefully remove the unfused spiral wound membrane sheet between the two fused sections to provide the finished spiral wound membrane leaf packet, which has two spiral wound membrane sheet sections (about 134 cm long and 104 cm wide for each section), two fused sections (about 104 cm long and 0.95 cm wide for each section), and one Surlyn® folding section (about 104 cm long and 5 cm wide). The obtained spiral wound membrane leaf packet 12 may have a very small portion of unfused membrane sheet material after removing the middle unfused membrane sheet between fused sections 25, 26, as illustrated in FIGS. 8 and 9.

### Example 2

### Spiral Wound Membrane Filtration Module Test

The purpose of the test of Example 2 was to illustrate the capability of spiral wound membrane leaf packets, as described herein, to resist cleaning conditions under pressure in food and dairy applications. Four membrane leaf packets manufactured essentially in accordance with the method as described in Example 1 were used to assemble a spiral wound membrane module, as described herein. The spiral wound membrane filtration module was tested while operating at an inlet pressure of about 310 kPa and an outlet pressure of about 103 kPa. The first part of the test included flushing the spiral wound membrane filtration module with water at about 41° C. for about 5 minutes. Then the spiral wound membrane filtration module was treated with caustic and chlorine (12% sodium hypochlorite solution diluted further with water to a chlorine concentration in the range of about 160-180 ppm, and adjusted with sodium hydroxide to a pH range from 10.7 to 11.0) for 12 hours at a temperature range of 103 to 126° C. After the treatment with caustic and chlorine, the spiral wound membrane filtration module was flushed twice with water for five minutes each time at about 41° C. The autopsy of the treated spiral wound membrane filtration module showed that there was no leak or damage at the folding area and the two fused areas under the pressurized caustic and chlorine cleaning conditions. The results show that the spiral wound membrane leaf packet of the present disclosure has the capability to resist caustic and chlorine cleaning conditions under pressure.

### Example 3

### Static Soak and Tensile Test

The purpose of the test of Example 3 was to illustrate the capability of a spiral wound membrane leaf packet to resist extended caustic and chlorine cleaning conditions. A more specific purpose was to see if the fused section is strong enough after extended exposure to accelerated caustic and chlorine cleaning conditions.

A spiral wound leaf packet that was made essentially in accordance with the method as described in Example 1 was used for the Example 3 testing. The leaf packet was cut down to about 15.2 cm wide with the fold area in the middle. The 15.2 cm long samples were cut down into about 2.54 cm wide strips. Three such strips were used as control, then 3 more were selected per week of testing (3 for week one, 3 for week two, 3 for week three, 3 for week four). The twelve samples are put in a beaker with a caustic and chlorine solution with a chlorine concentration of about 400 ppm and a pH in the range of 10.5 to 11.0. The temperature of the oven where the beaker sat was about 50° C. The samples were maintained under such conditions for four weeks with samples being removed every week ending on week four.

After soaking in the caustic and chlorine solution for four weeks, the samples were washed with warm water prior to tensile testing. Tensile tests were run for the 15 samples (12 chemically soaked and 3 controls) by following a slightly modified ASTM D903 adhesives peel strength testing standard. Tensile test was done on a United machine (Model: SFM-10) using a 45 kilogram load cell under a pressure of about 69 kPa. Grippers were set to hold the bottom side on the membrane area and top side on the Surlyn® folding area. The pull rate was about 1.27 cm per minute. The test results showed that although the Surlyn® film broke due to excessive elongation, the fused area did not break first. The result showed that the fused section was strong enough to resist high tension even after exposure to caustic and chlorine conditions over an extended period of time.

As used above, and throughout the description of the invention, the following terms, unless otherwise indicated, shall be understood to have the following meanings:

The term “glass transition temperature” in the present disclosure refers to a temperature or a range of temperatures for transition in amorphous materials from a hard and relatively brittle state into a molten or rubber-like state. Glass transition temperature is always lower than the melting temperature of such amorphous materials.

The term “non-permeable” as used herein in reference to the polymer resin sheet and polymeric resin folding section means it prevents a liquid from permeating through the item under standard filtration, separation, and cleaning conditions.

The term “substantially” as used herein means within an acceptable error range for the particular characteristic as determined by one of ordinary skill in the art, which will depend in part on how the value is measured, determined, evaluated, e.g., the limitations of the measurements systems. For example, “substantially” can mean within one or more than one standard deviations per the practice in the art.

The term “fuse”, “fusing”, “fusion”, or “fused” in the present disclosure refers to a process of joining separate, independent materials by application of heat and at least nominal pressure, such as the pressure created by laying a heat sealer on a surface, to approach or exceed the glass transition temperature of the materials to make the final composite substantially homogeneous, which cannot be separated without at least partial destruction of the joined materials. It is to be understood that the “fusing” may be accomplished utilizing a variety of heat sources including ultrasonic welding, radiation, and other known techniques or a combination of any heat and pressure sources that will bring about the physical change defined above.

The term “joint section” in the present disclosure refers to a section that is between one spiral wound membrane sheet section and the substantially non-permeable polymeric resin folding section. Besides the fusing method, a skilled artisan may appreciate that any other method such as applying a suitable adhesive to join one spiral wound membrane sheet section and the substantially non-permeable polymeric resin folding section may provide a leaf packet with comparable function. In the present disclosure, fusing is a preferred method to join one spiral wound membrane sheet section and the substantially non-permeable polymeric resin folding section.

Other possible embodiments may be made without departing from the scope of the invention, and it is understood that all disclosures made are to be interpreted as illustrative and not in a limiting sense.

We claim:

1. A spiral wound membrane leaf packet comprising a substantially non-permeable polymeric resin folding section.

2. The spiral wound membrane leaf packet according to claim 1, comprising at least two spiral wound membrane sheet sections, at least one substantially non-permeable polymeric resin folding section, and at least two joint sections, wherein the at least two joint sections are each between one spiral wound membrane sheet section and the substantially non-permeable polymeric resin folding section.

3. The spiral wound membrane leaf packet according to claim 2, comprising two spiral wound membrane sheet sections, one substantially non-permeable polymeric resin folding section, and two joint sections, wherein the two joint sections are each between one spiral wound membrane sheet section and the substantially non-permeable polymeric resin folding section.

4. The spiral wound membrane leaf packet according to claim 3, comprising at least two spiral wound membrane sheet sections, at least one substantially non-permeable polymeric resin folding section, and at least two fused sections, wherein the at least two fused sections are each between one spiral wound membrane sheet section and the substantially non-permeable polymeric resin folding section.

5. The spiral wound membrane leaf packet according to claim 4, comprising two spiral wound membrane sheet sections, one substantially non-permeable polymeric resin folding section, and two fused sections, wherein the two fused sections are each between one spiral wound membrane sheet section and the substantially non-permeable polymeric resin folding section.

6. The spiral wound membrane leaf packet according to claim 5, wherein the first fused section is formed by fusing a first longitudinal edge of a substantially non-permeable polymeric resin sheet to one edge of the first spiral wound membrane sheet section, and the second fused section is formed by fusing a second longitudinal edge of said substantially non-permeable polymeric resin sheet to one edge of the second spiral wound membrane sheet section.

7. The spiral wound membrane leaf packet according to claim 6, wherein said substantially non-permeable polymeric resin is an ionomer resin.

8. The spiral wound membrane leaf packet according to claim 7, wherein said ionomer resin is an ethylene and methacrylic acid copolymer, wherein the acid groups are partially neutralized with either zinc or sodium.

9. The spiral wound membrane leaf packet according to claim 8, wherein said ionomer resin is a material under the trade name Surlyn®.

10. A spiral wound membrane filtration module comprising one permeate tube, one or more permeate spacers, one or more feed spacer sheets, and one or more spiral wound membrane leaf packets, wherein said one or more spiral wound membrane leaf packets comprise a substantially non-permeable polymeric resin folding section.

11. The spiral wound membrane filtration module according to claim 10, wherein said one or more spiral wound membrane leaf packets comprise at least two spiral wound membrane sheet sections, at least one substantially non-permeable polymeric resin folding section, and at least two joint sections, wherein the at least two joint sections are each between one spiral wound membrane sheet section and the substantially non-permeable polymeric resin folding section.

12. The spiral wound membrane filtration module according to claim 11, wherein said one or more spiral wound membrane leaf packets comprise two spiral wound membrane sheet sections, one substantially non-permeable polymeric resin folding section, and two joint sections, wherein the two joint sections are each between one spiral wound membrane sheet section and the substantially non-permeable polymeric resin folding section.

13. The spiral wound membrane filtration module according to claim 11, wherein said one or more spiral wound membrane leaf packets comprise at least two spiral wound membrane sheet sections, at least one substantially non-permeable polymeric resin folding section, and at least two fused sections, wherein the at least two fused sections are each between one spiral wound membrane sheet section and the substantially non-permeable polymeric resin folding section.

14. The spiral wound membrane filtration module according to claim 13, wherein said one or more spiral wound membrane leaf packets comprise two spiral wound membrane sheet sections, one substantially non-permeable polymeric resin folding section, and two fused sections, wherein the two fused sections are each between one spiral wound membrane sheet section and the substantially non-permeable polymeric resin folding section.

15. A method to use a spiral wound membrane leaf packet in a spiral wound membrane filtration module in a purification or separation process, wherein said spiral wound membrane leaf packet comprises a substantially non-permeable polymeric resin folding section.

16. The method to use a spiral wound membrane leaf packet in a spiral wound membrane filtration module in a purification or separation process according to claim 15, wherein said spiral wound membrane leaf packet comprises at least two spiral wound membrane sheet sections, at least one substantially non-permeable polymeric resin folding section, and at least two joint sections, wherein the at least two joint sections are each between one spiral wound membrane sheet section and the substantially non-permeable polymeric resin folding section.

17. The method to use a spiral wound membrane leaf packet in a spiral wound membrane filtration module in a purification or separation process according to claim 15, wherein said spiral wound membrane leaf packet comprises two spiral wound membrane sheet sections, one substantially non-permeable polymeric resin folding section, and two joint sections, wherein the two joint sections are each between one spiral wound membrane sheet section and the substantially non-permeable polymeric resin folding section.

18. The method to use a spiral wound membrane leaf packet in a spiral wound membrane filtration module in a purification or separation process according to claim 16, wherein said spiral wound membrane leaf packet comprises at least two spiral wound membrane sheet sections, at least one substantially non-permeable polymeric resin folding section, and at least two fused sections, wherein the at least two fused sections are each between one spiral wound membrane sheet section and the substantially non-permeable polymeric resin folding section.

19. The method to use a spiral wound membrane leaf packet in a spiral wound membrane filtration module in a purification or separation process according to claim 18, wherein said spiral wound membrane leaf packet comprises two spiral wound membrane sheet sections, one substantially non-permeable polymeric resin folding section, and two fused sections, wherein the two fused sections are each between one spiral wound membrane sheet section and the substantially non-permeable polymeric resin folding section.

20. A process to make a spiral wound membrane leaf packet comprising fusing a spiral wound membrane sheet to a substantially non-permeable polymeric resin sheet.

21. The process to make a spiral wound membrane leaf packet according to claim 20, comprising:
a) providing a spiral wound membrane sheet comprising a membrane side and a membrane backing side;
b) providing a substantially non-permeable polymeric resin sheet and placing said substantially non-permeable polymeric resin sheet against said membrane sheet backing side, wherein a longitudinal direction of said substantially non-permeable polymeric resin sheet is perpendicular to a longitudinal direction of said spiral wound membrane sheet;
c) applying heat and pressure from said membrane side toward said backing side and fusing said spiral wound membrane sheet and said substantially non-permeable polymeric resin sheet along a first longitudinal edge of said substantially non-permeable polymeric resin sheet to form the first fused section;
d) applying heat and pressure from said membrane side toward said backing side and fusing said spiral wound membrane sheet and said substantially non-permeable polymeric resin sheet along a second longitudinal edge of said substantially non-permeable polymeric resin sheet to form the second fused section; and
e) removing a middle un-fused spiral wound membrane sheet section between the two fused sections to provide the completed spiral wound membrane leaf packet;
wherein step c) and step d) can be performed sequentially or substantially simultaneously, and the completed spiral wound membrane leaf packet has two spiral wound membrane sheet sections, one substantially non-permeable polymeric resin folding section, and two fused sections.

22. The process to make a spiral wound membrane leaf packet according to claim 20, comprising
a) providing two individual substantially identical spiral wound membrane sheets comprising a membrane side and a backing side;
b) providing a substantially non-permeable polymeric resin sheet;
c) disposing one edge of the first spiral wound membrane sheet on top of partial of the substantially non-permeable polymeric resin sheet along a first longitudinal edge of the substantially non-permeable polymeric resin sheet, and disposing one edge of the second spiral wound membrane sheet on top of partial of the substantially non-permeable polymeric resin sheet along a second longitudinal edge of the substantially non-permeable polymeric resin sheet, and the substantially non-permeable polymeric resin sheet is in contact with the backing side of the two spiral wound membrane sheets;
d) applying heat and pressure from the membrane side toward the backing side and fusing the spiral wound membrane sheet and the substantially non-permeable polymeric resin sheet along the first longitudinal edge of the substantially non-permeable polymeric resin sheet to form the first fused section; and
e) applying heat and pressure from the membrane side toward the backing side and fusing the spiral wound membrane sheet and the substantially non-permeable polymeric resin sheet along the second longitudinal edge of substantially non-permeable polymeric resin sheet to form the second fused section;
wherein step d) and step e) can be performed sequentially or substantially simultaneously, and the completed spiral wound membrane leaf packet has two spiral wound membrane sheet sections, one substantially non-permeable polymeric resin folding section, and two fused sections.
